(19) United States
(12) Patent Application Publication
(10) Pub. No.: US 2020/0320495 A1
(43) Pub. Date: Oct. 8, 2020

(54) Web-Based System and Method for Incorporating Georeferenced Imagery Into CAD Environment

(71) Applicant: Plexscape Mon. E.P.E., Athens (GR)

(72) Inventors: Lampros Kaliakatsos, Athens (GR); Vasilis Kokkinidis, Athens (GR)

(73) Assignee: Plexscape Mon. E.P.E., Athens (GR)

(21) Appl. No.: 16/377,427

(22) Filed: Apr. 8, 2019

(51) Int. Cl. G06Q 20/12; G06F 17/50; G06F 16/587

(52) U.S. Cl. CPC G06Q 20/123; G06F 16/587; G06F 17/50

(57) ABSTRACT

In one embodiment, a method for providing access to georeferenced imagery includes receiving, by a service provider, a request for georeferenced imagery sent by a georeferenced imagery module communicating with a design application executing on a computer, receiving, by the service provider, user identification information, using the identification information to determine whether the user is entitled to the requested georeferenced imagery, if the user is determined to be entitled to the requested georeferenced imagery, providing, to the design application, access to georeferenced imagery, and debiting user credits from an account associated with the user in proportion to the amount of access provided to the design application.

### TECHNICAL FIELD

The present disclosure relates generally to georeferencing and displaying time series of maps and aerial/satellite imagery in a CAD environment.

### BACKGROUND

For many purposes, such as monitoring environmental changes over time, the recovery and restoration after natural disasters (e.g. floods, earthquakes etc.) or the progress of construction sites, designers and decision-makers need to have access to time series of maps and imagery, so that they can track the differences between specific time points in the past and the present.

Georeferenced satellite and aerial imagery is a source of valuable insights in the design and construction process of civil engineering projects. It provides civil engineers with complete 3-dimensional (3D) geographical view of their project area, for any place in the world, and enables the incorporation of aerial/satellite imagery and terrain elevation data into the design process. By approaching the needs of the design process holistically, it enables the realistic representation of 2D and 3D designs inside Google Earth for example.

Conventionally, the use of satellite and aerial imagery is only possible through costly, time-consuming and error-prone procedures. Especially for engineering SME's (small and medium-sized enterprises), its acquisition and use is a significant challenge and a competitive disadvantage, often leading to design errors, additional revisions, delays, and ultimately, significant unexpected costs. In addition, free imagery sources (such as Google Earth, Bing Maps, USGS, OpenStreetMap etc.) usually have outdated content, and do not always provide sufficient permissions for commercial use or the creation of derivative work.

The acquisition of commercial high-quality imagery generated by local or global providers (such as Digital Globe, Airbus, Planet etc.) is possible mainly via reseller channels. However, existing channels have some major drawbacks:
Time loss: Imagery requests may take days or weeks to be processed
Significant cost: Mainly driven by constraints, such as minimum coverage area per order
Tedious ordering procedures
Need for GIS (geographic information system) skills to incorporate the delivered imagery into the CAD (computer aided design) environment

### Overview

Described herein is a method for providing access to time series of georeferenced imagery. The method includes receiving, by a service provider, a request for georeferenced imagery sent by a georeferenced imagery module communicating with a design application executing on a computer, receiving, by the service provider, user identification information, using the identification information to determine whether the user is entitled to the requested georeferenced imagery, if the user is determined to be entitled to the requested georeferenced imagery, providing, to the design application, access to georeferenced imagery, and debiting user credits from an account associated with the user in proportion to the amount of access provided to the design application. A non-transitory program storage device readable by a machine, embodying a program of instructions executable by the machine to perform this method is also described herein.

Also described herein is a method including using a design application executing on a computer of a user to construct an engineering plan, and executing a georeferenced imagery routine to: send to a service provider user identification information and a request for georeferenced imagery; obtain the requested georeferenced imagery based on the access information associated with the identification information; and incorporate the georeferenced imagery into the engineering plan. A non-transitory program storage device readable by a machine, embodying a program of instructions executable by the machine to perform this method is also described herein.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a high-level diagram of a system for providing georeferenced imagery in accordance with certain embodiments; and

FIG. 2 is a flow diagram showing a process by which a user obtains georeferenced imagery in accordance with certain embodiments; and

FIG. 3 is a flow diagram showing details of the imagery acquisition process in accordance with certain embodiments; and

FIG. 4 is a diagram showing the geometric characteristics of the images processed by the imagery delivery server 22 in accordance with certain embodiments.

### DESCRIPTION OF EXAMPLE EMBODIMENTS

Example embodiments are described herein in the context of a system 10 for providing georeferenced imagery. The following description is illustrative only and is not intended to be in any way limiting. Other embodiments will readily suggest themselves to those of ordinary skill in the art having the benefit of this disclosure. Reference will be made in detail to implementations of the example embodiments as illustrated in the accompanying drawings. The same reference indicators will be used to the extent possible throughout the drawings and the following description to refer to the same or like items.

In the description of example embodiments that follows, references to “one embodiment”, “an embodiment”, “an example embodiment”, “certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. The term “exemplary” when used herein means “serving as an example, instance or illustration.” Any embodiment described herein as “exemplary” is not necessarily to be construed as preferred or advantageous over other embodiments.

In the interest of clarity, not all of the routine features of the implementations described herein are shown and described. It will be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. Devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like), cloud storage, and other types of program memory.

Herein, reference to a computer-readable storage medium encompasses one or more non-transitory, tangible computer-readable storage media possessing structure. As an example and not by way of limitation, a computer-readable storage medium may include a semiconductor-based or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101. A computer-readable non-transitory storage medium may be volatile, nonvolatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

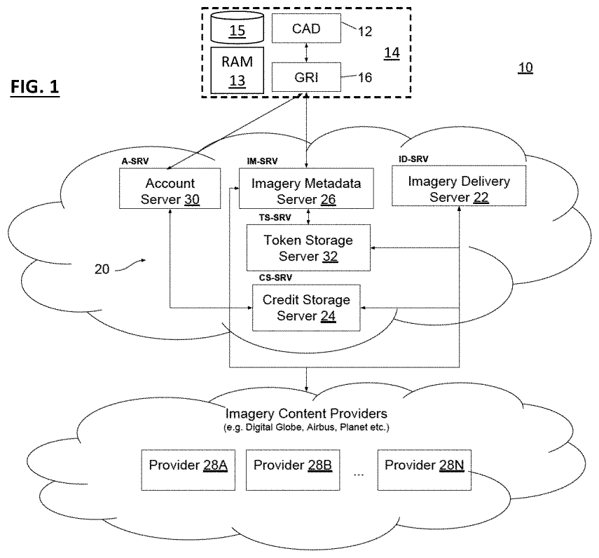

FIG. 1 is a high-level diagram of a system 10 for providing georeferenced imagery in accordance with certain embodiments. By way of illustration only, georeferenced imagery, which may be referred to as GR imagery herein, may be any of aerial or satellite images, thematic maps, historical maps, and the like, that are referenced to specific map coordinates associated with a physical location.

In FIG. 1, a design application 12, for example a CAD (computer aided design) program, executes on a user machine 14 to assist a user in the development of a design plan, for example a civil engineering project. Generally, the CAD program is used in the creation, modification, analysis, or optimization of a design. A georeferenced imagery module (GM module) or routine 16, which may be part of or separate from design application 12, is executable on machine 14, and is operable to request and obtain access to georeferenced imagery and incorporate it into the design plan. GM module 16 can be an add-on to the CAD application 12, or it can be separate locally- or remotely-running software that can interact with the CAD application, or it can be part of the CAD application itself. GM module 16 can be running on machine 14, or on a different machine (not shown) from CAD 12 and embedded in a CAD program environment.

System 10 also includes a georeferenced imagery service provider 20 in communication with user machine 14 and, directly or indirectly, with application 12 and/or GM module16. Service provider 20 comprises one or more devices. These include an image delivery server 22 that procures access to georeferenced imagery. In certain embodiments, image delivery server 22 obtains the imagery and delivers it to GM module 16. In certain embodiments, image delivery server 22 also tracks and reports user credit consumption to credit storage server 24, which logs usage and stores information about available credits per account and/or per user, as detailed further below.

Service provider 20 also includes imagery metadata server 26 that provides information about available imagery sets for the geographic location that is specified by the user or the GM module 16. Imagery metadata server 26 may retrieve the information about available imagery sets for the geographic location through requests to georeferenced imagery content provider(s) 28A, 28B . . . 28N (collectively, 28). In certain embodiments, some or all of the information about available imagery sets may be retrieved from databases internal to the system or under system control or access.

The imagery content providers 28 are third-party georeferenced imagery providers that may be independent of each other, and that source content such as aerial/satellite images, thematic maps, historical maps, and so on, as defined unexclusively above. Imagery content providers 28 expose one or more server endpoints, which are called by the image delivery server 22 with the required parameters and a private API access key. In certain embodiments, “expose” refers to publication of an API to the internet, which enables other services to call. Some or all of the required parameters may include those required by the communication protocol that the API implements, such as Tiled Web Map, WMTS, WMS etc. Typically, an imagery content provider 28 firstly validates the API key and then performs the requested action, e.g. to deliver the image, either directly to GRI module 16, or through service provider 20.

In certain embodiments, service provider 20 also includes an account server 30, which operates to track accounts. An account can be associated with an individual, a company, organization, governmental agency, and so on. In certain embodiments, each tracked account contains information about user credits that are available to one or more users sharing the account. The credits enable access to the georeferenced data provided by providers 28 under specific user rights. User credits operate as measurement units of service usage, which may vary per provider and other factors, such as imagery type, date, resolution, etc. In certain embodiments, a user credit corresponds to a predefined monetary value.

Credit storage server 24 tracks user credits, debiting them or augmenting them commensurately with usage and purchases, promotions, and so on, and updates the account server 30 accordingly. This is performed on a user basis and/or on an account basis. In certain embodiments, the user credits are brokered by the service provider 20, whereby the service provider obtains provider credits from the imagery content providers 28, for example through purchase, and brokers access to the imagery content by distributing user credits to individual accounts and/or users 14. Such distribution can be through purchase, promotion, and so on. In certain embodiments, the user credits are of a different value than the provider credits, such that the provider is able to profit from the difference in credit values.

In certain embodiments, service provider 20 also includes a token storage server 32, which creates and stores tokens used by GRI module 16 for downloading the georeferenced imagery. In certain embodiments, for each image, the image delivery server 22 calls the token storage server 32 to generate a new unique token for a respective image request data object (IRDO) generated by the image delivery server 22. Tokens may also include information that is used to apply service rules, such as access expiration date/time, the number of times an image can be served etc.

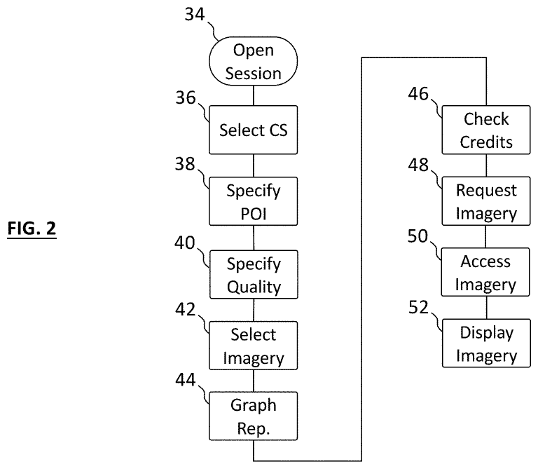

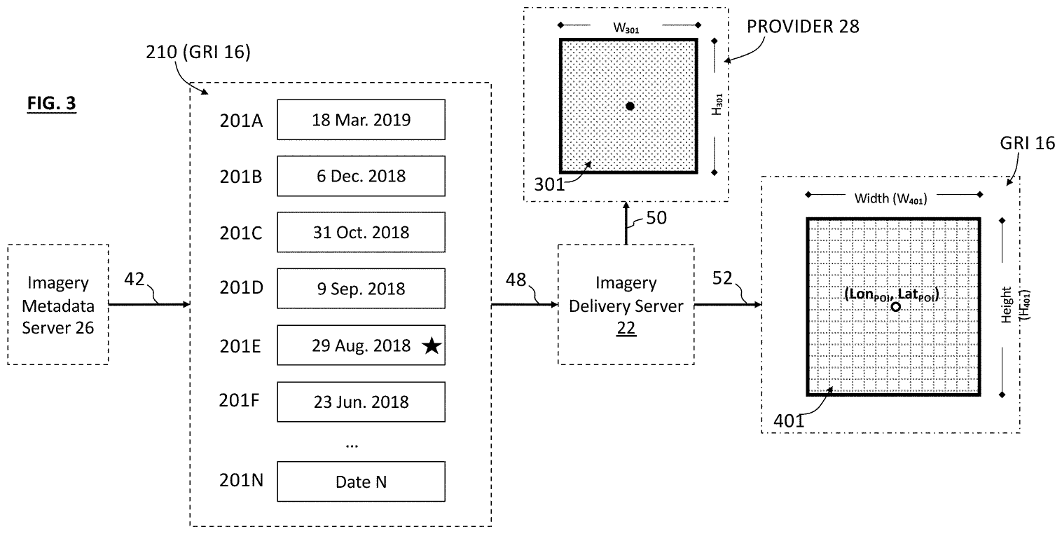

FIG. 2 is a flow diagram showing a process by which a user of GM module 16 obtains georeferenced imagery in accordance with certain embodiments, while FIG. 3 illustrates details of the image acquisition process in accordance with certain embodiments. It will be understood that the order of steps in the flow diagrams is not intended to be limiting, and different orders are contemplated.

At 34, GM module 16 opens a session with service provider 20, providing authentication and other information to the service provider as necessary. User identification information is associated with a user account and indicates the nature of access to which the user is entitled, as tracked by account server 30. As explained above, an account can be associated with a person, company, organization, governmental agency, and so on, and in certain embodiments, each tracked account contains information about user credits that are available to one or more users sharing the account. In certain embodiments, the account can be associated with a device, such as a laptop or desktop computer, smart phone, tablet, sensor, and so on.

At 36, the user selects the coordinate system (CS) to be used. Typically, CAD programs make use of planar (cartesian) coordinates. The common (and recommended) practice in the design of AEC projects, is to reference drawings to the standard coordinate systems, which have been defined by governmental or local authorities, companies, universities, organizations etc. Those coordinate systems allow the bidirectional transformation between cartesian and geographic coordinates. In some cases, the CAD user may work on arbitrary coordinates.

At 38, the user specifies a point of interest (POI). The POI is necessary to locate the exact position of the project on the globe. The user may specify the geographic coordinates of the POI, as below:
Directly, by setting the latitude/longitude of the location.
Indirectly, by specifying a point on the drawing. In this case, based on the selected CS, the cartesian coordinates may be transformed into geographic.

At 40, the user specifies the required imagery quality, for example zoom level and/or ground resolution. Other criteria can also be set, such as date range, image type, etc.

At 42, the user selects the desired one or more imagery sets, for example through a dialog box shown by a user interface (UI) of the GRI module 16. GRI module 16 calls the image metadata server 26 of service provider 20 to retrieve a list of available imagery sets for the specific POI and the previously specified criteria. Alternatively, the user may choose to always access the latest available aerial/satellite imagery for the POI. This can be more generalized, whereby the user may choose to always access a specific aerial/satellite imagery dataset for the POI or based on criteria, such as ‘the latest’. In certain embodiments, an imagery set may be a time-series set—for example a group of images referring to the same geographic location at different times) for the specific POI and the previously specified criteria.

At 44, the user is optionally provided with a graphical representation of the area covered by the selected imagery set(s), inside the CAD environment. Each imagery set may cover the whole globe or a specific region. In the latter case, a series of geographic coordinates may be provided. The user may desire an overview of the cover area (e.g. wanting to check if it covers the whole project area), and so may choose to graphically display its boundaries in the CAD. In this case, based on the selected coordinate system, the GM module 16 converts the latitude/longitude of each point into cartesian X/Y, which can be subsequently displayed (and or highlighted) in the CAD drawing area.

At 46, GM module 16 checks if the user has enough user credits available. In certain embodiments, this check is performed by the service provider 20, or by content provider 28. Once the user completes the configuration, GM module 16 calls account server 30 to confirm that the user has enough user credits to access the required imagery. In this manner the extent of access to the georeferenced imagery to which the user is entitled is determined.

At 48, GM module 16 requests access to the selected imagery set(s). GM module 16 requests access to the imagery by sending geometric and other necessary data (e.g. the ID of the selected imagery, the image type etc.) to the imagery metadata server 26. For each image, imagery metadata server 26 generates an image request data object (IRDO) that contains:
The location and resolution of the image, and other necessary information (e.g. the imagery set ID)
The private API key that uniquely identifies the service provider 20 to the respective imagery content providers 28. In certain embodiments, those API keys should be protected and never be transmitted to the GM module 16
Other information, such as internet address (URL) of the third-provider and other parameters

For each image, the image metadata server 26 calls the token storage server 32 to generate a new unique token for the respective IRDO, as mentioned above. Tokens may also include information that is used to apply service rules, such as access expiration date/time, the number of times it can be served, etc. In certain embodiments, the list of tokens is returned to the GRI module 16.

At 50, GM module 16 accesses the imagery from provider(s) 28. In certain embodiments, GM module 16 calls the image delivery server 22 to download the images, by using the respective tokens. Image delivery server 22 uses the token to retrieve the IRDO from the token server 32. The token contains all the required information to make the request to the georeferenced imagery provider 28. If the request to the georeferenced imagery provider succeeds, the image delivery server will relay the image back to GM module 16. In certain embodiments, image delivery server 22 secures for the user access to the imagery, but does not perform the actual delivery. In certain embodiments, the delivery is from the imagery provider to GM 16. In certain embodiments, for technical reasons, for example to reduce bandwidth passed through the system servers and in the absence of security risks, the delivery server 22 sends a link to GRI module 16, which link can be used by GM module 16 to download the imagery from the imagery provider 28 or other site or server affiliated therewith. Since GRI modulel6 is embedded in the CAD environment, the downloaded imagery can be incorporated directly into the design process of an engineering plan without the need to download the imagery (for example using a browser) and then manually import it into the CAD. In certain embodiments, depending on permissions and agreement, the downloaded imagery is incorporated transiently (for view-only purposes) or permanently into the design process of an engineering plan.

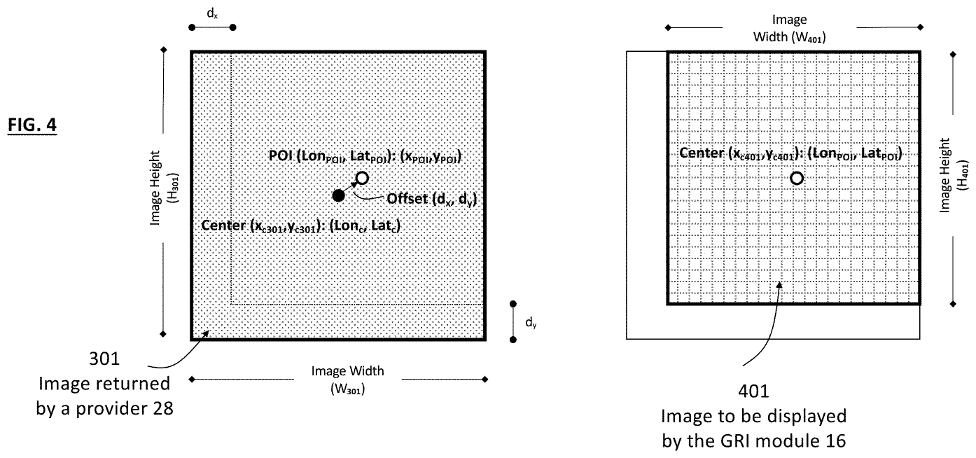

With reference to FIGS. 3 and 4, in certain embodiments, the center-pixel coordinates of the image(s) 401 returned to GRI 16 must correspond to the geographic location of the POI. This is achieved by post-processing the images 301 received by the imagery delivery server 22 or GRI module 16, as shown in FIG. 4. The post-processing, which can be performed by GM 16 or by delivery server 22, or both, can be as follows:
Image 301 is a bitmap with size (width, height)=(W₃₀₁, H₃₀₁) that is received from provider 28.
Image 401 is a bitmap of size (width, height)=(W₄₀₁, H₄₀₁) that is displayed by GM module 16.

Any pixel coordinates (x, y) in bitmap 301 is mapped to a geographic location (Lon, Lat) through a georeferencing function (F):

F(x, y)=(Lon, Lat) (1)

For the center pixel (x_{c}, y_{c})=(W₃₀₁/2, H₃₀₁/2) of the bitmap the formula becomes:

F(x_{c}, y_{c})=(Lon_{c}, Lat_{c}) (2)

Conversely, a georeferencing function F′ can be used to compute the corresponding pixel coordinates (x, y) for a given geographic location (Lon, Lat) in the bitmap:

F′(Lon, Lat)=(x, y) (3)

With the use of (2) can be calculated the coordinates (x_{POI}, y_{POI}) of the pixel that corresponds to the latitude and longitude of the POI (Lon_{POI}, Lat_{POI}):

F′(Lon_{POI}, Lat_{POI})=(x_{POI}, y_{POI}) (4)

As illustrated, image 401 is the portion of bitmap 301 having as center the pixel coordinates (x_{POI}, y_{POI}) and size (W₄₀₁, H₄₀₁). That ensures that the center of the image 401 displayed by GM module 16 coincides with the geographic location of the POI.

Given this, imagery server 22 must ensure that the image retrieved from the selected provider 28 has enough padding to allow the cropping of portion 401. This can be accomplished by enabling server 22 to calculate the minimum size of image 301, with the following method:

As illustrated, image 301 must be equal to or greater than 401 by an amount that corresponds to the offset between the center and pixel coordinates of the POI:

(dₓ, d_{y})=(x_{POI}, y_{POI})−(x_{c}, y_{c}) (5)

It is noted that the size (W₃₀₁, H₃₀₁) of the image 301 must be the minimum possible allowed by the communication protocol (Tiled Web Map, WMTS, WMS etc.) used by the provider 28, in order to reduce the necessary storage space, bandwidth and data traffic of the system.

Given the width and height (W₄₀₁, H₄₀₁) of image 401, the minimum extents of image 301 is determined by:

(W₃₀₁, H₃₀₁)≥(W₄₀₁, H₄₀₁)+(dₓ, d_{y}) (6)

At 52, GM module 16 displays the georeferenced images obtained in CAD. GRI module 16 uses the returned image bytes to create an image object. The image can also contain copyright information. According to the user permissions, the image can be available under the following terms:
Level 1—Temporary: Images are not stored locally on the computer 14 running GM module 16 and are available in view-mode only during the specific session of the GM module or CAD. That means that if the user closes the GM module or CAD, images are purged from the computer memory and the CAD environment. In certain embodiments the imagery at this level are cached impermanently, for example in a RAM 13, and are only accessible on a one-time basis when the session is open. In certain embodiments, the imagery is discarded when the session is terminated.
Level 2—Extended: Images are not stored locally on the computer running the GRI module 16, but they can be retrieved, based on the expiration date and/or other rules set in the imagery token. In this case, the GM module 16 stores the token along with the geometric definition of the image, locally or inside the CAD drawing.
Level 3—Permanent: Images are downloaded and stored in a local or remote folder in the user's network. Each time the GRI module 16 runs they can be retrieved and displayed again. In certain embodiments the imagery at this level is stored permanently, for example in a hard drive 15 or the like, and can be accessed at will. In certain embodiments, and with proper permissions, the access can include certain permitted manipulations of the imagery, including for instance sharing with others and commercial uses.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted based on the foregoing description. This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

We claim:

1. A method for providing access to georeferenced imagery, comprising:
receiving, by a service provider, a request for georeferenced imagery sent by a georeferenced imagery module communicating with a design application executing on a computer;
receiving, by the service provider, user identification information;
using the user identification information to determine whether the user is entitled to the requested georeferenced imagery;
if the user is determined to be entitled to the requested georeferenced imagery, providing, to the design application, access to georeferenced imagery; and
debiting user credits from an account associated with the user in proportion to the amount of access provided to the design application.

2. The method of claim 1 further comprising:
receiving, by the service provider, a coordinate reference system selection.

3. The method of claim 2, wherein the received coordinate reference system is a non-Cartesian reference system.

4. The method of claim 1, further comprising:
receiving, by the service provider, a point of interest (POI) for the georeferenced imagery.

5. The method of claim 4, further comprising:
providing a list of the available imagery sets associated with the POI.

6. The method of claim 4, wherein the POI is a direct specification of latitude and longitude of a location.

7. The method of claim 4, wherein the POI is an indirect specification of latitude and longitude of a location based on a point in a drawing.

8. The method of claim 1, further comprising:
receiving, by the service provider, an image quality indication relating to zoom level and/or ground resolution.

9. The method of claim 8, further comprising:
providing a list of the available imagery associated with the image quality indication.

10. The method of claim 9, further comprising receiving, by the service provider, a selection from the list of available imagery, the selection including an ID of a selected image.

11. The method of claim 10, further comprising generating an image request data object (IRDO) of the selected image.

12. The method of claim 11, wherein the IRDO includes one or more of:
a location and resolution of the image,
a private API key that uniquely identifies the service provider, and
an internet address URL of a third-party provider of the image

13. The method of claim 12, further comprising:
generating, by the service provider, a unique token for the IRDO.

14. The method of claims 12, further comprising:
receiving, by the service provider, a call to deliver the image, the call including the unique token;
using the token to retrieve the IRDO of the image;
using the IRDO to access the image from the third-party provider; and
delivering the image to the design application.

15. The method of claim 14, wherein the delivering is performed by the service provider.

16. The method of claim 1, further comprising:
obtaining service provider credits for access to the georeferenced imagery; and
debiting service provider credits from a service provider account in proportion to the amount of access provided to the design application.

17. The method of claim 1, wherein the access to georeferenced imagery provided to the user is one of:
1) temporary, view-mode only, wherein the imagery is not stored locally and is discarded at session termination,
2) extended, wherein the imagery is not stored locally but is retrievable in subsequent sessions, or
3) permanent, wherein the imagery is stored locally and is retrievable in subsequent sessions.

18. A method comprising:
using a design application executing on a computer of a user to construct an engineering plan; and
executing a georeferenced imagery routine to:
send to a service provider user identification information and a request for georeferenced imagery;
obtain the requested georeferenced imagery based on the access information associated with the identification information; and
incorporate the georeferenced imagery into the engineering plan.

19. The method of claim 18, wherein the georeferenced imagery is obtained from the service provider.

20. The method of claim 18, wherein the georeferenced imagery is obtained from a content provider.

21. The method of claim 18, wherein executing a georeferenced imagery routine further comprises:
sending to a service provider a coordinate reference system selection.

22. The method of claim 19, wherein the coordinate reference system is a non-Cartesian reference system.

23. The method of claim 18, wherein executing a georeferenced imagery routine further comprises:
sending to a service provider a point of interest (POI) for the georeferenced imagery.

24. The method of claim 23, wherein executing a georeferenced imagery routine further comprises:
receiving from the service provider a list of the available imagery sets associated with the POI.

25. The method of claim 23, wherein the POI is a direct specification of latitude and longitude of a location.

26. The method of claim 23, wherein the POI is an indirect specification of latitude and longitude of a location based on a point in a drawing.

27. The method of claim 23, wherein incorporating the georeferenced imagery into the engineering plan comprises:
offsetting an obtained georeferenced image to ensure that its center corresponds to the POI.

28. The method of claim 18, wherein executing a georeferenced imagery routine further comprises:
sending to a service provider an image quality indication relating to zoom level and/or ground resolution.

29. The method of claim 28, wherein executing a georeferenced imagery routine further comprises:
receiving from the service provider a list of the available imagery associated with the image quality indication.

30. The method of claim 29, wherein executing a georeferenced imagery routine further comprises:
sending to the service provider a selection from the list of available imagery, the selection including an ID of a selected image.

31. The method of claim 30, wherein executing a georeferenced imagery routine further comprises:
sending to the service provider a call to deliver the selected image, the call including the a unique token associated with the selected image.

32. The method of claim 18, wherein executing a georeferenced imagery routine further comprises:
receiving from the service provider a series of geographic coordinates of a cover area;
displaying an overview of the cover area using including boundaries of the cover area; and
converting latitude and longitude of each points in the boundaries into cartesian coordinates for display.

33. The method of claim 18, wherein executing a georeferenced imagery routine further comprises:
depending on user permission, performing one of the following:
making the georeferenced imagery available in view mode during a specific session without locally storing the georeferenced imagery,
retrieving the georeferenced imagery based on prescribed rules in a locally-stored token and a geometric definition of the georeferenced imagery, without locally storing the georeferenced imagery, or
storing the georeferenced imagery locally or in a network of the user.

34. The method of claim 18, wherein the access to georeferenced imagery provided to the user is one of:
1) temporary, view-mode only, wherein the imagery is not stored locally and is discarded at session termination,
2) extended, wherein the imagery is not stored locally but is retrievable in subsequent sessions, or
3) permanent, wherein the imagery is stored locally and is retrievable in subsequent sessions.

35. A non-transitory program storage device readable by a machine, embodying a program of instructions executable by the machine to perform a method for providing access to georeferenced imagery, the method comprising:
receiving, by a service provider, a request for georeferenced imagery sent by a georeferenced imagery module communicating with a design application executing on a computer;
receiving, by the service provider, user identification information;
using the identification information to determine whether the user is entitled to the requested georeferenced imagery;
if the user is determined to be entitled to the requested georeferenced imagery, providing, to the design application, access to georeferenced imagery; and
debiting user credits from an account associated with the user in proportion to the amount of access provided to the design application.

36. The non-transitory program storage device of claim 35, wherein the method for providing access to georeferenced imagery further comprises:
receiving, by the service provider, a coordinate reference system selection, and a point of interest (POI) for the georeferenced imagery.

37. The non-transitory program storage device of claim 36, wherein the method for providing access to georeferenced imagery further comprises:
providing a list of the available imagery sets associated with the POI.

38. The non-transitory program storage device of claim 35, wherein the method for providing access to georeferenced imagery further comprises:
receiving, by the service provider, an image quality indication relating to zoom level and/or ground resolution;
providing a list of the available imagery associated with the image quality indication; and
receiving, by the service provider, a selection from the list of available imagery, the selection including an ID of a selected image.

39. The non-transitory program storage device of claim 36, wherein the method for providing access to georeferenced imagery further comprises:
generating an image request data object (IRDO) of the selected image, wherein the IRDO includes one or more of:
a location and resolution of the image,
a private API key that uniquely identifies the service provider, and
an internet address URL of a third-party provider of the image;
generating, by the service provider, a unique token for the IRDO;
receiving, by the service provider, a call to deliver the image, the call including the unique token;
using the token to retrieve the IRDO of the image;
using the IRDO to access the image from the third-party provider; and
delivering the image to the design application.

40. The non-transitory program storage device of claim 35, wherein the access to georeferenced imagery provided to the user is one of:
1) temporary, view-mode only, wherein the imagery is not stored locally and is discarded at session termination,
2) extended, wherein the imagery is not stored locally but is retrievable in subsequent sessions, or
3) permanent, wherein the imagery is stored locally and is retrievable in subsequent sessions.

41. A non-transitory program storage device readable by a machine, embodying a program of instructions executable by the machine to perform a method comprising:
using a design application executing on a computer of a user to construct an engineering plan; and
executing a georeferenced imagery routine to:
send to a service provider user identification information and a request for georeferenced imagery;
obtain the requested georeferenced imagery based on the access information associated with the identification information; and
incorporate the georeferenced imagery into the engineering plan.

42. The non-transitory program storage device of claim 41, wherein the method wherein the georeferenced imagery is obtained from the service provider.

43. The non-transitory program storage device of claim 41, wherein the georeferenced imagery is obtained from a content provider.

44. The non-transitory program storage device of claim 41, wherein executing a georeferenced imagery routine further comprises:
sending to a service provider a point of interest (POI) for the georeferenced imagery.

45. The non-transitory program storage device of claim 44, wherein executing a georeferenced imagery routine further comprises:
receiving from the service provider a list of the available imagery sets associated with the POI.

46. The non-transitory program storage device of claim 44, wherein incorporating the georeferenced imagery into the engineering plan comprises:
offsetting an obtained georeferenced image to ensure that its center corresponds to the POI.

47. The non-transitory program storage device of claim 41, wherein executing a georeferenced imagery routine further comprises:
sending to a service provider an image quality indication relating to zoom level and/or ground resolution;
receiving from the service provider a list of the available imagery associated with the image quality indication;
sending to the service provider a selection from the list of available imagery, the selection including an ID of a selected image; and
sending to the service provider a call to deliver the selected image, the call including the a unique token associated with the selected image.

48. The non-transitory program storage device of claim 41, wherein executing a georeferenced imagery routine further comprises:
receiving from the service provider a series of geographic coordinates of a cover area;
displaying an overview of the cover area using including boundaries of the cover area; and
converting latitude and longitude of each points in the boundaries into cartesian coordinates for display.

49. The non-transitory program storage device of claim 41, wherein executing a georeferenced imagery routine further comprises:
depending on user permission, performing one of the following:
making the georeferenced imagery available in view mode during a specific session without locally storing the georeferenced imagery,
retrieving the georeferenced imagery based on prescribed rules in a locally-stored token and a geometric definition of the georeferenced imagery, without locally storing the georeferenced imagery, or
storing the georeferenced imagery locally or in a network of the user.

50. The non-transitory program storage device of claim 41, wherein the access to georeferenced imagery provided to the user is one of:
1) temporary, view-mode only, wherein the imagery is not stored locally and is discarded at session termination,
2) extended, wherein the imagery is not stored locally but is retrievable in subsequent sessions, or
3) permanent, wherein the imagery is stored locally and is retrievable in subsequent sessions.
